(19) United States
(12) Patent Application Publication
(10) Pub. No.: US 2011/0142130 A1
(43) Pub. Date: Jun. 16, 2011

(54) PICTURE DECODER

(75) Inventors: Chia-Ping Lin, Kaohsiung City (TW); Chao-Tsung Huang, Kaohsiung City (TW); Ying-Hung Lu, Kaohsiung County (TW)

(73) Assignee: Novatek Microelectronics Corp., Hsinchu (TW)

(21) Appl. No.: 12/748,365

(22) Filed: Mar. 26, 2010

(30) Foreign Application Priority Data
Dec. 10, 2009 (TW) 98142335

(51) Int. Cl. H04N 7/26

(52) U.S. Cl. 375/240.16; 375/240.25; 375/E07.027

(57) ABSTRACT

A picture decoder having a stream buffer, an H.264/AVC decoder, and a processor is provided. The stream buffer stores stream data. The H.264/AVC decoder decodes the stream data and performs an operation on a slice layer specified in the H.264/AVC standard to reorder reference pictures recorded in a reference picture list according to the stream data and generate a plurality of decoded pictures. The processor executes a program to perform an operation on a sequence layer specified in the H.264/AVC standard and mark the decoded pictures.

### CROSS-REFERENCE TO RELATED APPLICATION

This application claims the priority benefit of Taiwan application serial no. 98142335, filed on Dec. 10, 2009. The entirety of the above-mentioned patent application is hereby incorporated by reference herein and made a part of specification.

### BACKGROUND OF THE INVENTION

1. Field of the Invention

The present invention generally relates to a picture decoder, and more particularly, to a picture decoder conforming to the H.264/AVC standard.

2. Description of Related Art

H.264/AVC is the latest video compression technique developed by the joint video team (JVT) formed by the ITU-T video coding experts group (VCEG) and the ISO/IEC moving picture experts group (MPEG). H.264/AVC is broadly applied in different fields, such as the new blu-ray DVD standard, the digital video broadcasting over terrestrial (DVB-T), the digital video broadcasting satellite (DVB-S), and other communication and multimedia video compression applications rely on its high compression ratio. H.264/AVC adopts such compression techniques as multiple reference frame, variable block-size motion compensation, quarter-pixel precision for motion compensation, weighted prediction, and arithmetic coding in order to achieve a higher compression ratio.

The H.264/AVC video compression standard supports the multiple reference frame technique to achieve a better compression performance. In order to specify the reference pictures to be used, all referable pictures are first sorted according to the specification of the H.264/AVC video compression standard to generate a reference picture list, so that an encoder/decoder can obtain the information of the reference pictures from the reference picture list according to index information of the reference picture list and carry out subsequent encoding/decoding operations. The reference pictures are actually referable pictures that are previously compressed, and each of the referable pictures can be marked as a reference picture through a decoded reference picture marking operation. This operation is performed after the entire picture is encoded/decoded. Each picture may be marked with “used for short-term reference”, “used for long-term reference”, or “unused for reference”, and the marking result may affect the establishment of the reference picture list.

In the H.264/AVC video compression standard, each picture contains a plurality of slices, and each slice establishes its own reference picture list according to a slice header thereof, wherein the reference picture list is used by the entire slice. According to the H.264/AVC encoding standard, each picture is encoded in unit of macroblocks (MBs) (i.e., each picture is divided into a plurality of MBs and the MBs are respectively encoded). Since each picture is encoded in unit of MBs according to the H.264/AVC encoding standard and each MB is composed of 16×16 pixels, the picture can be further divided into blocks of 4×4 pixels to be further processed.

A reference picture list establishing method is disclosed by Lin et al. in an article titled “A 160K Gates/4.5 KB SRAM H.264 Video Decoder for HDTV Applications” (published on IEEE JOURNAL OF SOLID-STATE CIRCUITS, VOL. 42, NO. 1 in January, 2007), wherein the task is mostly performed by software. In the present disclosure, the decoding of the slice header and the reordering of the reference picture list are both carried out by software, while decoding operations below the slice layer are taken care of by hardware. With such a structure, the software and hardware communicate with each other frequently and many interrupt signals or other signals have to be issued to switch between the operations of the software and the hardware in order to decode a picture. The more slices the picture to be decoded has, the more interrupt signals are required and accordingly the lower the efficiencies of the software and the hardware are.

A hardware-only design is disclosed by Lou et al. in an article titled “Updating Strategy Based Architecture for Reference Picture Management in H.264/AVC” (published on ASICON in 2007), wherein the initialization of reference picture lists, the reordering of the reference picture lists, the marking of reference pictures, and other related operations are all carried out by hardware, and the data related to each picture is stored in a memory of the hardware. Accordingly, the corresponding task control and distribution is in a fixed pattern and not so flexible. In particular, many errors in the sequence layer will be caused when the stream data to be processed contains errors. As a result, system control is restricted.

### SUMMARY OF THE INVENTION

Accordingly, the present invention is directed to a picture decoder that distributes it tasks between software and hardware based on a picture layer, wherein the operation on a sequence layer is performed by the software, the operation on the picture layer is performed by both the software and the hardware according to the task distribution, and the operation on a slice layer is accelerated by the hardware, so that a balance between hardware acceleration and software flexibility is achieved.

The present invention provides a picture decoder including a stream buffer, a H.264/AVC decoder, and a processor. The stream buffer stores stream data. The H.264/AVC decoder performs decoding operations below a picture layer. To be specific, the H.264/AVC decoder decodes the stream data and performs an operation on a slice layer to reorder reference pictures recorded in a reference picture list and generate a plurality of decoded pictures. The processor executes a program to perform operations on a sequence layer. To be specific, the processor marks the decoded pictures.

According to an embodiment of the present invention, the processor issues an instruction to the H.264/AVC decoder through the program, and the H.264/AVC decoder extracts a corresponding data from the stream data and decodes the corresponding data according to the instruction, so as to sequentially decode each slice in the stream data and eventually decode an entire picture. Besides, after the H.264/AVC decoder decodes the picture according to the instruction and generates a target picture, the H.264/AVC decoder issues a feedback signal to the processor such that the program marks the target picture.

According to an embodiment of the present invention, when the H.264/AVC decoder decodes any slice, the H.264/AVC decoder first reorders the reference pictures in the reference picture list according to the stream data, selects some of the decoded pictures as reference pictures according to the new order of the reference pictures in the reference picture list, and decodes the slice according to the selected reference picture.

According to an embodiment of the present invention, before the H.264/AVC decoder decodes any picture, the processor initializes the reference picture lists of two possible slice types (including a P-slice and a B-slice) to be referred by the hardware by executing the program.

According to an embodiment of the present invention, when the processor initializes the reference picture lists of the two possible slice types, if the value of a gaps_in_frame_num_value_allowed_flag of the picture decoder is 1, the program determines whether there is a number jump among frame numbers of the reference pictures recorded in a decoded picture buffer, and if there is the number jump, the program inserts some non-existing pictures into the reference pictures recorded in the reference picture lists to be initialized and then initializes the reference picture lists.

According to an embodiment of the present invention, the H.264/AVC decoder reorders the reference pictures recorded in the corresponding reference picture list according to sorting data of the slice in the stream data.

According to an embodiment of the present invention, the program decodes the stream data to obtain the frame number and an order count of the target picture.

According to an embodiment of the present invention, the program decodes the stream data to obtain a reference picture marking and a long term frame index of the target picture.

According to an embodiment of the present invention, when the H.264/AVC decoder decodes macroblocks (MBs) related to a spatial direct mode in a B slice, the data of the decoded pictures includes a reference index of zero and a motion vector between ±1 corresponding to each block in each MB.

According to an embodiment of the present invention, when the H.264/AVC decoder decodes the MBs related to a temporal direct mode in a B slice, the data of the decoded pictures includes the data of reference pictures and a motion vector corresponding to each block in each MB.

According to an embodiment of the present invention, the reference picture list records the order of the reference pictures required when the H.264/AVC decoder decodes a P slice or a B slice.

According to an embodiment of the present invention, all the slices in the first decoded picture generated by the H.264/AVC decoder by decoding the stream data are I slices.

According to an embodiment of the present invention, the picture decoder further includes a decoded picture data buffer and a candidate picture data buffer. The decoded picture data buffer stores data of the decoded pictures. The candidate picture data buffer temporarily stores picture data generated when the H.264/AVC decoder decodes the stream data.

According to an embodiment of the present invention, the data of the decoded pictures includes frame numbers, pixel values, and reference picture markings of the decoded pictures.

According to an embodiment of the present invention, the data of the decoded pictures includes long term frame indexes, pixel values, and reference picture markings of the decoded pictures.

As described above, in the present invention, the operation of reordering reference pictures in a reference picture list on the slice layer is performed by a H.264/AVC decoder (hardware), so that it is not needed to issue many interrupt signals and accordingly the efficiency of the entire system is improved. In addition, the storage and distribution of data (for example, the frame number, memory location, and long term frame index of each picture in a film) above the picture layer and the provision of appropriate data to the hardware are all performed by a program, so that the flexibility of the entire system is improved.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a functional block diagram of a picture decoder according to an embodiment of the present invention.

FIG. 2 is a flowchart illustrating how a picture is decoded according to an embodiment of the present invention.

FIG. 3 is a flowchart of H.264/AVC decoding according to an embodiment of the present invention.

FIG. 4 is a flowchart of H.264/AVC decoding according to another embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

A typical H.264/AVC decoder determines the number of reference pictures to be used according to the attribute of the slice. No reference picture is needed when an I slice is decoded, a reference picture is selected from a reference picture list 0 (RefList0) for decoding a P slice, and a reference picture is selected from one or each of the reference picture list 0 (RefList0) and a reference picture list 1 (RefList1) for decoding a B slice. In each slice, each 8×8 block may be decoded by referring to a different reference picture. However, the reference picture list and the number of reference pictures to be selected are restricted by the attribute of the slice. In addition, the decoder determines which reference picture is not used for reference anymore according to the information in the slice header after each picture is decoded. This procedure may keep all the existing reference pictures or discard more than one or even all reference pictures.

The discarded reference pictures are removed from the reference picture list when a next picture is decoded. However, new reference pictures are added. When a picture is decoded, whether the picture can be used for reference is determined according to information in the header of the network abstraction layer (NAL). If the picture can be used for reference, the picture is added into the reference picture list to be referred later. Otherwise, the picture is not added into the reference picture list. However, it should be noted that the picture is added into the reference picture list after the unused reference pictures are removed, the removing command does not remove the current reference picture unless the picture cannot be used for reference.

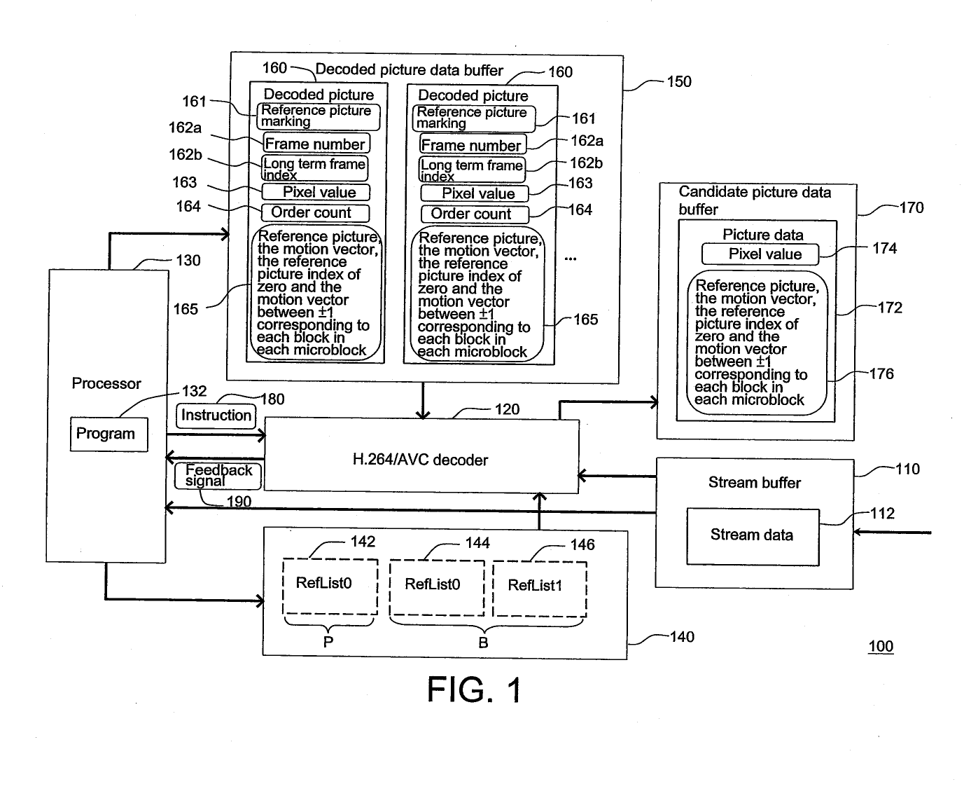

FIG. 1 is a functional block diagram of a picture decoder 100 according to an embodiment of the present invention. Referring to FIG. 1, the picture decoder 100 includes a stream buffer 110, a H.264/AVC decoder 120, and a processor 130. The stream buffer 110 stores a stream data 112. The stream data 112 is generated according to the H.264/AVC encoding standard, and which includes video information and/or audio information. The H.264/AVC decoder 120 reorders the reference pictures recorded in at least one of the reference picture lists 142, 144, and 146 according to an instruction corresponding to a slice layer in the stream data and performs decoding operations on the picture layer and the slice layer specified in the H.264/AVC standard to decode and store the stream data 112 and generate a plurality of candidate pictures. The reference picture lists 142, 144, and 146 are all stored in an initial reference picture list data buffer 140, wherein the reference picture list 142 records the initial order of reference pictures used by the H.264/AVC decoder 120 for decoding a P slice, the reference picture list 144 records the initial order of reference pictures in the RefList0 used by the H.264/AVC decoder for decoding a B slice, and the reference picture list 146 records the initial order of reference pictures in the RefList1 used by the H.264/AVC decoder for decoding a B slice. In the specification of H.264/AVC, the reference picture list 142 is the initial RefList0 used for decoding P slices, the reference picture list 144 is the initial RefList0 used for decoding B slices, and the reference picture list 146 is the initial RefList1 used for decoding B slices. It should be noted that the RefList0 used for decoding P slices and the RefList0 used for decoding B slices are two different reference picture lists. Additionally, in an embodiment of the present invention, only the reference picture list 142 among the reference picture lists 142, 144, and 146 is used by the H.264/AVC decoder 120 for decoding a P slice, and only the reference picture lists 144 and 146 among the reference picture lists 142, 144, and 146 are used by the H.264/AVC decoder 120 for decoding a B slice.

In the embodiment described above, the reference picture lists 142, 144, and 146 stored in the initial reference picture list data buffer 140 are three “initial” picture lists. When the H.264/AVC decoder 120 decodes a slice, it loads the corresponding reference picture list(s) from the initial reference picture list data buffer 140 and reorders reference pictures in the corresponding reference picture list(s) according to the stream data. Herein the reordered reference picture list(s) is/are the reference picture list(s) used by the H.264/AVC decoder 120 for decoding the slice. However, it should be noted that the initial reference picture list data buffer 140 is not compulsory in the present invention. For example, in another embodiment of the present invention, the picture decoder 100 does not have the initial reference picture list data buffer 140, and the H.264/AVC decoder 120 establishes the corresponding initial reference picture list(s) according to the type of the slice to be decoded and then reorders reference pictures in the initial reference picture list(s) to obtain the desired reference picture list(s).

While establishing the initial reference picture lists 142, 144, and 146, a program 132 first determines whether there is any number jump among the frame numbers (frame_num) of the reference pictures recorded in the initial reference picture list(s) 142, 144, and/or 146, and if there is number jump, the program 132 inserts some non-existing pictures into the reference picture list before initializing the corresponding reference picture list(s) 142, 144, and/or 146.

The processor 130 executes the program 132 to perform operations on a sequence layer specified in the H.264/AVC standard, so as to mark the decoded pictures 160.

The processor 130 issues an instruction 180 to the H.264/AVC decoder 120 through the program 132, and the H.264/AVC decoder 120 extracts corresponding data from the stream data 112 according to the instruction 180 and decodes the corresponding data to sequentially decode one or multiple slices and store the decoding result into the candidate pictures. After the H.264/AVC decoder 120 generates the decoded pictures in response to the instruction 180, it issues a feedback signal 190 to the processor 130 such that the program 132 marks a target picture among the decoded pictures. Additionally, in an embodiment of the present invention, after the processor 130 receives the feedback signal 190 from the H.264/AVC decoder 120, the program 132 decodes the stream data 112 to obtain a reference picture marking 161, a long term frame index 162b, and an order count 164 of the target picture.

Because the decoding operations on the picture layer and the slice layer are performed by the H.264/AVC decoder 120 through hardware acceleration while the operation on the sequence layer is performed by the processor 130 through the execution of the program 132, the flexibility of the picture decoder provided by the present invention is improved compared to the previous technique disclosed by Lou et al. (wherein all decoding operations are carried out by hardware) since the decoding parameters can be adjusted according to the decoding requirement through the program 132. In addition, in the other conventional technique disclosed by Lin et al., the decoding operation on the slice layer is performed by hardware while the decoding operations on the picture layer and the sequence layer are performed by software. Because there are too many slices to be decoded, the communication between the hardware and the software is too frequent and accordingly the decoding efficiency is very low. Contrarily, in the present invention, because the decoding operations on the picture layer and the slice layer are performed by the H.264/AVC decoder 120 through hardware acceleration while the operation on the sequence layer is performed by the processor 130 through the execution of the program 132, the communication between the H.264/AVC decoder 120 and the program 132 is reduced and accordingly the decoding efficiency is improved. Thereby, a balance is achieved between hardware acceleration and software flexibility in the present invention compared to the two conventional decoding techniques.

When the H.264/AVC decoder 120 decodes any slice, it selects some of the decoded pictures 160 as reference pictures according to the order of the reference pictures which is the reordered result of at least one of the initial reference picture lists 142, 144, and 146 and decodes the slice according to the selected reference pictures. To be specific, if the slice to be decoded is a P slice, the H.264/AVC decoder 120 selects some of the decoded pictures 160 as reference pictures according to the reordered reference picture list which is the reordered result of the initial reference picture list 142 and decodes the P slice according to the selected reference pictures. If the slice to be decoded is a B slice, the H.264/AVC decoder 120 selects some of the decoded pictures 160 as reference pictures according to the reordered reference picture lists which is the reordered result of the initial reference picture lists 144 and 146 and decodes the B slice according to the selected reference pictures.

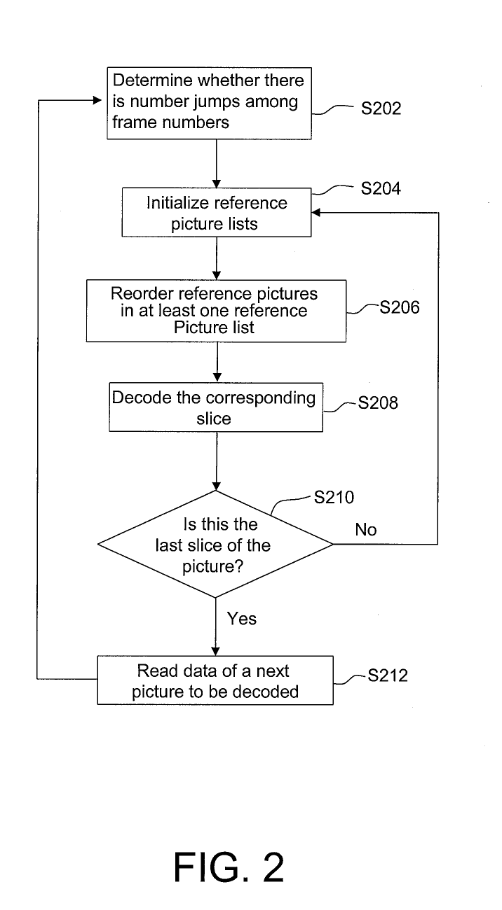

FIG. 2 is a flowchart illustrating how a picture is decoded according to an embodiment of the present invention. Referring to FIG. 2, first, the program 132 detects whether the value of a parameter gaps_in_frame_num_value_allowed_flag in the sequence layer is 1. If the value of gaps_in_frame_num_value_allowed_flag is 1, in step S202, the program 132 first determines whether there is number jump among the frame numbers in the picture layer and inserts some non-existing pictures into the places with number jumps before it initializes the reference picture lists. To be specific, when the processor 130 initializes at least one of the reference picture lists 142, 144, and 146, if the value of gaps_in_frame_num_value_allowed_flag of the picture decoder 100 is 1, the program 132 determines whether there is number jump among the frame numbers of the reference pictures recorded in the reference picture list(s) 142, 144, and/or 146 to be initialized. If there are number jumps, the program 132 inserts some non-existing pictures into the reference pictures recorded in the reference picture list(s) 142, 144, and/or 146. Then, the program 132 initializes the order of reference picture list on the picture layer to establish at least one of the initial reference picture lists 142, 144, and 146. The reference picture list 142 used for decoding P slices is initially ordered according to the frame numbers and the long term frame indexes of the pictures. The reference picture lists 144 and 146 used for decoding B slices are initially ordered according to the order counts and the long term frame indexes of the pictures. Thereafter, while decoding a slice, the H.264/AVC decoder 120 reorders the reference pictures recorded in at least one of the initial reference picture lists 142, 144, and 146 depending on whether the stream data 112 contains reordering information, so as to obtain the reordered reference picture list. However, if the value of gaps_in_frame_num_value_allowed_flag is 0, the program 132 skips step S202 and executes step S204 directly. In step S204, the program 132 performs decoding and calculations on the stream data 112 to establish at least one of the initial reference picture lists 142, 144, and 146 in the initial reference picture list data buffer 140.

Next, in step S206, every time when the H.264/AVC decoder 120 is about to decode a slice, the H.264/AVC decoder 120 reorders the reference pictures recorded in the corresponding initial reference picture list(s) 142, 144, and/or 146 according to the corresponding sorting data of the slice in the stream data 112. To be specific, if the slice to be decoded is a P slice, the H.264/AVC decoder 120 reorders the reference pictures recorded in the reference picture list 142 according to the corresponding sorting data in the stream data 112. If the slice to be decoded is a B slice, the H.264/AVC decoder 120 reorders the reference pictures recorded in the corresponding reference picture lists 144 and 146 according to the corresponding sorting data in the stream data 112. If the slice to be decoded is an I slice, the H.264/AVC decoder 120 does not reorder the reference pictures in any reference picture list.

In step S208, the H.264/AVC decoder 120 selects some of the decoded pictures 160 as reference pictures according to the order of the reference pictures recorded in the reordered reference picture lists and decodes the slice according to the selected reference pictures. To be specific, if the slice to be decoded is a P slice, the H.264/AVC decoder 120 selects some of the decoded pictures 160 as reference pictures according to the order of the reordered result of initial reference picture list 142 and decodes the P slice according to the selected reference pictures. If the slice to be decoded is a B slice, the H.264/AVC decoder 120 selects some of the decoded pictures 160 as reference pictures according to the order of the reordered result of initial reference picture lists 144 and 146 and decodes the B slice according to the selected reference pictures.

After that, in step S210, the H.264/AVC decoder 120 determines whether the slice decoded in step S208 is the last slice of the picture to be decoded. If the slice decoded in step S208 is not the last slice of the picture to be decoded, steps S204-S208 are repeated to decode the next slice. If the slice decoded in step S208 is the last slice of the picture to be decoded, it is determined that all the slices of the picture have been decoded. In step S212, the program 132 and the H.264/AVC decoder 120 perform decoding and calculations on the stream data 112 to read data of a next picture to be decoded from the stream buffer 110. Thereafter, steps S202-S210 are repeated.

Referring to FIG. 1 again, the program 132 stores data, which is demanded by the H.264/AVC decoder 120 when the H.264/AVC decoder 120 decodes pictures, into a decoded picture data buffer 150. For example, in order to allow the H.264/AVC decoder 120 to perform the operation of reordering the reference picture lists on the slice layer, the H.264/AVC decoder 120 has to obtain a reference picture marking 161 and one of a frame number 162a and a long term frame index 162b of each referable picture. To carry out the operation of motion compensation, the decoded pixel value 163 of each referable picture is also necessary. These data is stored in the decoded picture data buffer 150 and read by the H.264/AVC decoder 120 after being processed by the program 132.

In addition, if the H.264/AVC decoder 120 is about to decode microblocks (MBs) related to a spatial direct mode in a B slice, the reference index of zero and a motion vector between ±1 corresponding to each block in each MB of each referable picture is also required, and which can be stored in the decoded picture data buffer 150 according to the actual requirement. In other words, when the H.264/AVC decoder 120 is about to decode MBs related to the spatial direct mode in the B slice, the program 132 stores the data 165 of the reference picture, the motion vector, the reference index of zero and the motion vector between ±1 corresponding to each block in each MB of each referable picture into the decoded picture data buffer 150 to be used by the H.264/AVC decoder 120.

On the other hand, if H.264/AVC decoder 120 is about to initialize the reference picture list for decoding a B slice, the order counts 164 of all referable pictures are desired, and which can be stored into the decoded picture data buffer 150 according to the requirement. In other words, when the H.264/AVC decoder 120 is about to initialize the reference picture list corresponding to a B slice or decode MBs in a temporal direct mode, the program 132 first stores the order counts 164 of all referable pictures into the decoded picture data buffer 150 to be used by the H.264/AVC decoder 120.

In addition, if the H.264/AVC decoder 120 is about to decode MBs related to a temporal direct mode in a B slice, the data of reference pictures and a motion vector corresponding to each block in each MB of each referable picture is desired, and which can be stored in the decoded picture data buffer 150 according to the requirement. In other words, when the H.264/AVC decoder 120 is about to decode MBs related to the temporal direct mode in a B slice, the program 132 first stores the data of reference pictures and motion vector corresponding to each block in each MB of each referable picture into the decoded picture data buffer 150 to be used by the H.264/AVC decoder 120.

The picture decoder 100 further includes a candidate picture data buffer 170 for temporarily storing picture data 172 generated when the H.264/AVC decoder 120 decodes the stream data 112. The picture data 172 may include but is not limited to the pixel values 174 of each picture and data 176 of the reference picture, the motion vector, the reference picture index of zero and the motion vector between ±1 corresponding to each block in each microblock 176.

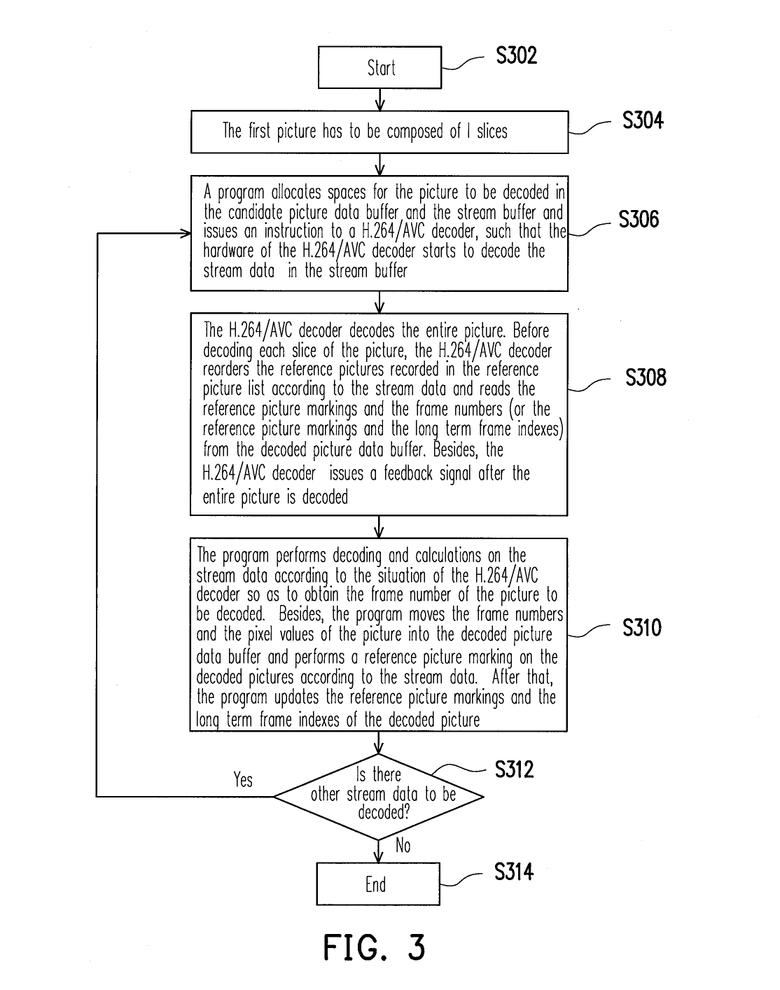

FIG. 3 is a flowchart of H.264/AVC decoding according to an embodiment of the present invention. Referring to FIG. 3, according to the specification of H.264/AVC, the first picture to be decoded has to be composed of I slices (steps S302 and S304). Then, in step S306, the program 132 allocates spaces for the picture to be decoded in the candidate picture data buffer 170 and the stream buffer 110 and issues an instruction 180 to the H.264/AVC decoder 120, such that the hardware of the H.264/AVC decoder 120 starts to decode the stream data 112 in the stream buffer 110. In step S308, the H.264/AVC decoder 120 decodes the entire picture. Before decoding each slice of the picture, the H.264/AVC decoder 120 reorders the reference pictures recorded in the reference picture list(s) 142, 144, and/or 146 according to the stream data 112 and reads the reference picture markings 161 and the frame numbers 162a (or the reference picture markings 161 and the long term frame indexes 162b) from the decoded picture data buffer 150. Besides, the H.264/AVC decoder 120 issues a feedback signal 190 to the processor 130 after the entire picture is decoded. In step S310, the program 132 performs decoding and calculations on the stream data 112 according to the situation of the H.264/AVC decoder 120 so as to obtain the frame number of the picture to be decoded. Besides, the program 132 moves the frame numbers 162a and the pixel values 163 of the picture into the decoded picture data buffer 150 and performs a reference picture marking on the decoded pictures 160 according to the stream data 112. After that, the program 132 updates the reference picture markings 161 and the long term frame indexes 162b in the decoded picture 160. In step S312, the program 132 or the H.264/AVC decoder 120 determines whether there is other stream data to be decoded. If there is still other stream data to be decoded, steps S306-S312 are repeated. If there is no more stream data to be decoded, the entire decoding operation is completed (step S314).

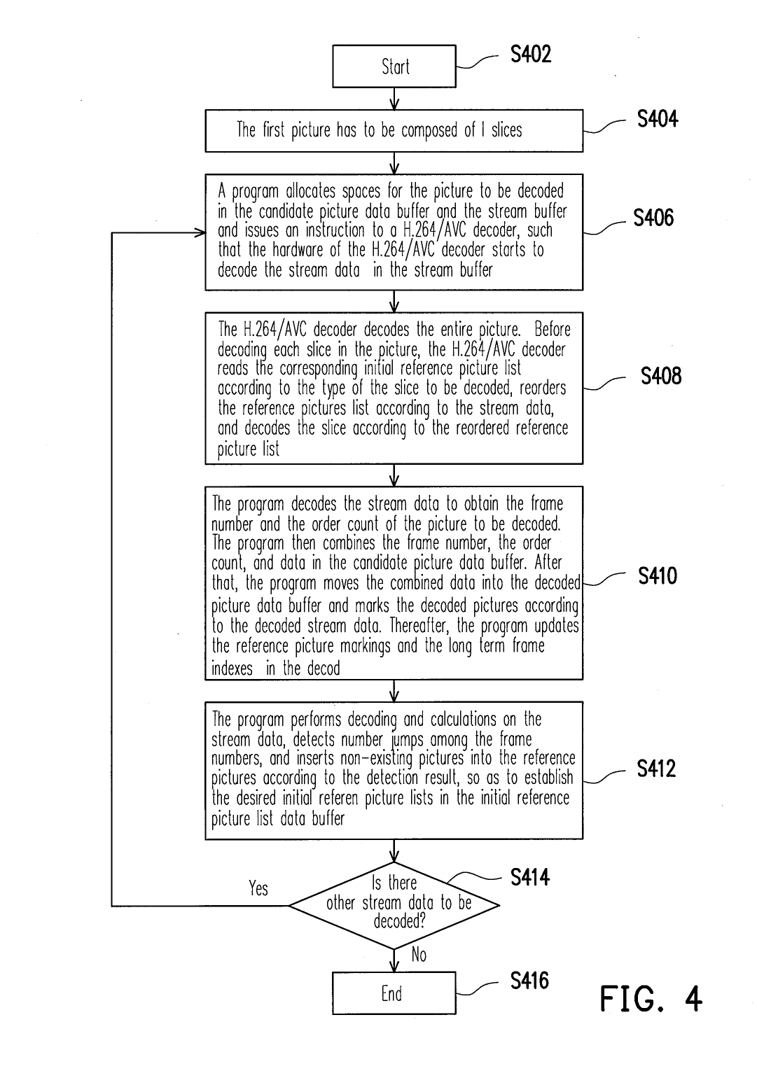

FIG. 4 is a flowchart of H.264/AVC decoding according to another embodiment of the present invention. Referring to FIG. 4, similarly, according to the specification of H.264/AVC, the first picture to be decoded has to be composed of I slices (steps S402 and S404). Then, in step S406, the program 132 allocates spaces in the candidate picture data buffer 170 and the stream buffer 110 for the picture to be decoded and issues an instruction 180 to the H.264/AVC decoder 120, such that the hardware of the H.264/AVC decoder 120 starts to decode the stream data 112 in the stream buffer 110. In step S408, the H.264/AVC decoder 120 decodes the entire picture. Before decoding each slice in the picture, the H.264/AVC decoder 120 reads the corresponding initial reference picture list(s) 142, 144, and/or 146 according to the type of the slice to be decoded, reorders the reference pictures recorded in the reference picture list(s) 142, 144, and/or 146 according to the stream data 112, and decodes the slice according to the reordered reference picture list(s) 142, 144, and/or 146. In step S410, the program 132 decodes the stream data 112 to obtain the frame number 162a and the order count 164 of the picture to be decoded. The program 132 then combines the frame number 162a, the order count 164, and data in the candidate picture data buffer 170. After that, the program 132 moves the combined data into the decoded picture data buffer 150 and marks the decoded pictures 160 according to the decoded stream data 112. Thereafter, the program 132 updates the reference picture markings 161 and the long term frame indexes 162b in the decoded picture data buffer 150. In step S412, the program 132 performs decoding and calculations on the stream data 112, detects number jumps among the frame numbers, and inserts non-existing pictures into the reference pictures according to the detection result, so as to establish the desired initial reference picture list(s) 142, 144, and/or 146 in the initial reference picture list data buffer 140. In step S414, the program 132 or the H.264/AVC decoder 120 determines whether there is other stream data to be decoded. If there is still other stream data to be decoded, steps S406-S414 are repeated. If there is no other stream data to be decoded, the entire decoding operation is completed (step S414).

As described above, in the present invention, the decoding operations on the picture layer and the slice layer are performed by the H.264/AVC decoder 120 through hardware acceleration, and the operation on the sequence layer is performed by the processor 130 through the execution of the program 132. Thereby, a balance between hardware acceleration and software flexibility is achieved.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A picture decoder, comprising:
a stream buffer, for storing a stream data;
a H.264/AVC decoder, for reordering reference pictures recorded in at least one reference picture list, and for performing operations on a picture layer and a slice layer specified in a H.264/AVC standard to decode the stream data and generate a plurality of decoded pictures; and
a processor, for executing a program to perform an operation on a sequence layer specified in the H.264/AVC standard, so as to mark the decoded pictures.

2. The picture decoder according to claim 1, wherein the processor issues an instruction to the H.264/AVC decoder through the program, and the H.264/AVC decoder extracts corresponding data from the stream data and decodes the corresponding data according to the instruction, so as to sequentially generate one or multiple slices of a target picture among the decoded pictures;
wherein after the H.264/AVC decoder generates the slices of the target picture in response to the instruction, the H.264/AVC decoder issues a feedback signal to the processor such that the program marks the target picture.

3. The picture decoder according to claim 2, wherein when the H.264/AVC decoder decodes one of the slices, the H.264/AVC decoder selects a portion of the decoded pictures as reference pictures according to an order of the reference pictures recorded in the reordered reference picture list and decodes the slice according to the selected reference pictures.

4. The picture decoder according to claim 2, wherein before the H.264/AVC decoder decodes one of the slices, the processor initializes the reference picture list by executing the program.

5. The picture decoder according to claim 4, wherein when the processor initializes the reference picture list, if a value of a parameter gaps_in_frame_num_value_allowed_flag of the picture decoder has a value 1, the program determines whether there is a number jump among frame numbers of the reference pictures recorded in the reference picture list, and when there is the number jump, the program inserts a plurality of non-existing pictures into the reference pictures recorded in the reference picture list.

6. The picture decoder according to claim 4, wherein the H.264/AVC decoder reorders the reference pictures recorded in the reference picture list according to a sorting data of the slice in the stream data.

7. The picture decoder according to claim 2, wherein the program decodes the stream data to obtain a reference picture marking, a frame number, and an order count of the target picture.

8. The picture decoder according to claim 2, wherein the program decodes the stream data to obtain a reference picture marking, a long term frame index, and an order count of the target picture.

9. The picture decoder according to claim 2, wherein when the H.264/AVC decoder decodes microblocks (MBs) related to a spatial direct mode in a B slice, data of the decoded pictures comprises a reference index of zero and a motion vector between ±1 corresponding to each block in each MB of each referable picture.

10. The picture decoder according to claim 2, wherein when the H.264/AVC decoder decodes MBs related to a temporal direct mode in a B slice, data of the decoded pictures comprises data of reference pictures and a motion vector corresponding to each block in each MB of each referable picture.

11. The picture decoder according to claim 1, wherein the reference picture list records an order of reference pictures required when the H.264/AVC decoder decodes a P slice or a B slice.

12. The picture decoder according to claim 1, wherein all slices of the first decoded picture generated by the H.264/AVC decoder by decoding the stream data are I slices.

13. The picture decoder according to claim 1 further comprising:
a decoded picture data buffer, for storing data of the decoded pictures; and
a candidate picture data buffer, for temporarily storing picture data generated when the H.264/AVC decoder decodes the stream data.

14. The picture decoder according to claim 13, wherein data of the decoded pictures comprises frame numbers, pixel values, and reference picture markings of the decoded pictures.

15. The picture decoder according to claim 13, wherein data of the decoded pictures comprises long term frame indexes, pixel values, and reference picture markings of the decoded pictures.
